(19) United States
(12) Patent Application Publication
(10) Pub. No.: US 2025/0036773 A1
(43) Pub. Date: Jan. 30, 2025

(54) LARGE LANGUAGE MODEL ASSISTED CYBERSECURITY PLATFORM

(71) Applicant: Crowdstrike, Inc., Sunnyvale, CA (US)

(72) Inventors: Theo Chihaia, Bucharest (RO); Daniel Radu, Bucharest (RO); Adrian-Cosmin Cojocaru, Bucharest (RO)

(21) Appl. No.: 18/425,973

(22) Filed: Jan. 29, 2024

Related U.S. Application Data
(60) Provisional application No. 63/515,488, filed on Jul. 25, 2023.

(51) Int. Cl. G06F 21/57; G06F 16/22; G06F 16/2452

(52) U.S. Cl. CPC G06F 21/577; G06F 16/22; G06F 16/24522; G06F 2221/034

(57) ABSTRACT

A system and method of using generative AI to convert NL queries to database commands for accessing one or more databases. The method includes receiving a natural language (NL) request for information associated with a private network. The method includes providing the NL request to an artificial intelligence (AI) model trained to identify, from a plurality of access objects associated with a plurality of databases and a plurality of event types, a particular access object that provides access to one or more event datasets associated with the NL request. The method includes generating, by a processing device and using the AI model, a database request associated with the particular access object based on the NL request.

### CROSS-REFERENCE TO RELATED APPLICATIONS

This application claims the benefit of U.S. Provisional Application Ser. No. 63/515,488 entitled “LARGE LANGUAGE MODEL ASSISTED CYBER-SECURITY PLATFORM,” filed Jul. 25, 2023, the disclosure of which is incorporated herein by reference in its entirety.

### TECHNICAL FIELD

The present disclosure relates generally to cybersecurity, and more particularly, to systems and methods of using generative artificial intelligence (AI), such as large language models (LLMs), to convert natural language queries to database commands for accessing one or more databases.

### BACKGROUND

Cybersecurity is the practice of protecting critical systems and sensitive information from digital attacks. Cybersecurity techniques are designed to combat threats against networked systems and applications, whether those threats originate from inside or outside of an organization.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for using generative artificial intelligence (AI), such as LLMs, to convert natural language queries to database commands for accessing one or more databases, according to some embodiments;

FIG. 2 is a block diagram depicting an example environment for using the LLMs in FIG. 1 to convert natural language queries to database commands for accessing one or more databases, according to some embodiments;

FIG. 3A is a block diagram depicting an example of the cybersecurity management (CSM) system in FIG. 1, according to some embodiments;

FIG. 3B is a block diagram depicting an example environment for using a CSM system, according to some embodiments

FIG. 4 is a flow diagram depicting a method of using generative artificial intelligence to convert natural language queries to database commands for accessing one or more databases, according to some embodiments; and

FIG. 5 is a block diagram of an example computing device that may perform one or more of the operations described herein, in accordance with some embodiments.

### DETAILED DESCRIPTION

A database (e.g., database platform) is an organized collection of data stored and accessed electronically through the use of a computing device, such as a laptop or server. Small databases can be stored on a file system, while large databases can be hosted on computer clusters or cloud storage. An application programming interface (API) allows multiple software components to communicate with each other using a set of definitions and communication protocols. A computing device (e.g., an endpoint device) of a private network (e.g., customer network, corporate network, and/or the like) uses multiple APIs (e.g., sometimes referred to as access objects) to access and/or retrieve the different types of data that are stored in the databases. For example, a user of an endpoint device seeking to access a particular type of data (e.g., detection data, vulnerability data, threat data, hunting data, application data, and/or the like), first identifies the particular database (or databases) that stores the particular type of data and then identifies the particular API (or group of APIs) that is used to communicate with the particular database.

However, as the number of databases increases to accommodate the increasing data size (e.g., 1 gigabyte (GB), 2 GB, and so on) and/or number of different data types, so do the number of APIs that are used to access the databases. Consequently, users often find it increasingly difficult to accurately identify the appropriate database and API that is used to access the database. This causes the user to repeatedly send data requests to various databases using various APIs, all of which return large sets of unwanted data across the network. This iterative process of repeatedly sending data requests until the correct set of data is returned not only causes network congestion and network latency, but also forces the database platform and/or the endpoint devices of the private network to waste their computing resources (e.g., memory resources, power resources, processing resources) when processing each of these data requests. Thus, there is a long-felt but unsolved need to solve the problems of navigating through large volumes of data in a database platform.

Aspects of the present disclosure address the above-noted and other deficiencies by using generative artificial intelligence (e.g., LLMs, Recurrent Neural Network, text generating model based on diffusion techniques) to convert natural language queries to database commands for accessing one or more databases. The present disclosure describes a cybersecurity management (CSM) system that uses one or more AI models, such as LLMs, to identify event data based on a natural language (NL) query (e.g., one or more user questions) and convert the NL query to a database query (e.g., Structured Query Language (SQL)) for accessing the event data from the one or more databases that store the event data.

An admin device on a private network executes an application (e.g., sometimes referred to as, Falcon UI viewer). A user (e.g., administrator of the private network) uses the application to send platform-specific questions to the CSM management system (sometimes referred to a Natural Language Processing (NLP) assistant). The platform-specific questions may be, for example, “Which threat actors target my industry?”, “What is my exposure to CVE-2023-12345?” or “Which hosts in my environment have Team Viewer or Any Desk installed?” The CSM system generates answers to the platform-specific questions that are made up of a summarized response enclosing the resources and/or data (e.g., event data) of interest to the user as specified by the question, formatted and beautified in a human-readable way. Furthermore, the user may ask the CSM system questions that cannot be directly mapped to specific data platform queries, but imply general concepts that are widely used in the cybersecurity space. The CSM system can help users that are not that technical to ask the right questions, by providing context whenever a question like that comes up.

In an illustrative embodiment, a cybersecurity management (CSM) system collects a plurality of event datasets (e.g., a process control call, a file management call, a device management call, an information management call, a communication call, a protection call, and/or the like) from a plurality of endpoint devices of a private network. Each event dataset is respectively associated with a particular endpoint device of the plurality of endpoint devices. The CSM system indexes (e.g., categorizes and stores) the plurality of event datasets into one or more databases based on a plurality of event types associated with the plurality of event datasets. The CSM system generates, for the plurality of databases, a plurality of APIs associated with the plurality of event types. Each API of the plurality of APIs provides access to a unique event dataset associated with a unique event type of the plurality of event types. The CSM system receives an NL request from an endpoint device on the private network. The CSM system provides the NL request to an LLM trained to identify, from the plurality of APIs, a particular API that provides access to one or more event datasets associated with the NL request. The CSM system converts, by the LLM, the NL request to a SQL request to be used for communicating with the particular API. The CSM system provides, to the endpoint device, access to the one or more event datasets based on the SQL request. For example, the CSM system may send the SQL request to the endpoint device, which in turn, may use the SQL request to communicate with the particular API and retrieve the one or more event datasets from the database.

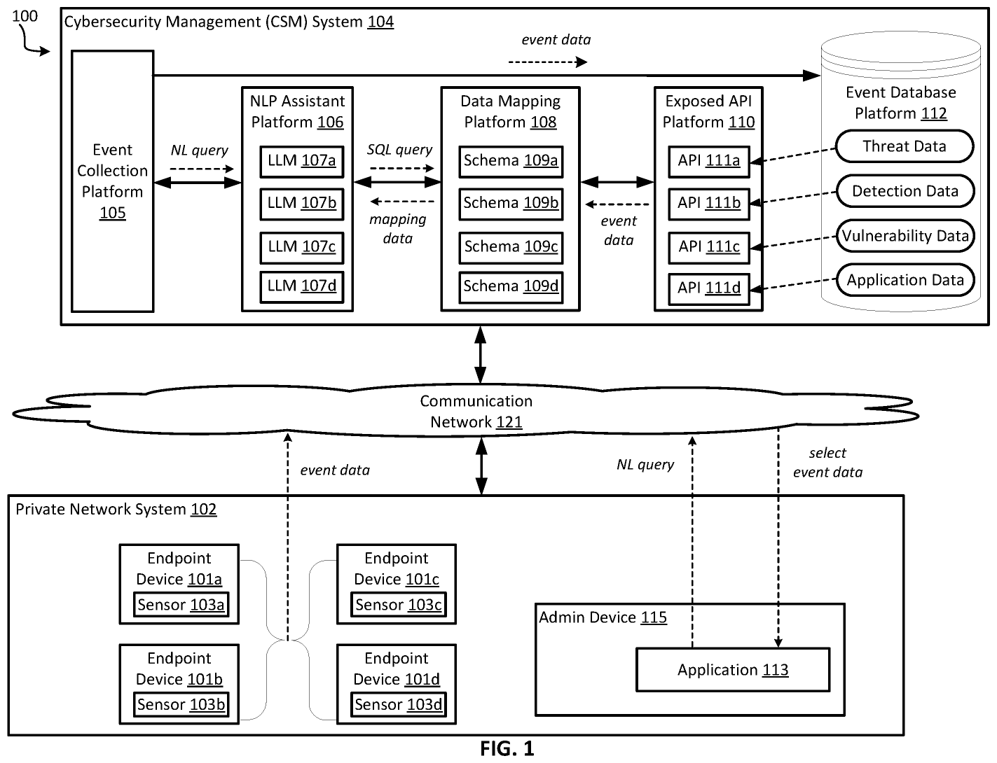

FIG. 1 is a block diagram depicting an example environment for using generative artificial intelligence (AI), such as LLMs, to convert natural language queries to database commands for accessing one or more databases, according to some embodiments. The environment 100 includes and/or executes a CSM system 104, a private network system 102 (e.g., a corporate network, a local area network (LAN), a wide area network (WAN), a personal area network (PAN)). The private network system 102 includes endpoint devices 101 (e.g., endpoint device 101a, 101b, 101c, 101d) and an administrative device 115 (shown in FIG. 1 as, admin device) that are communicably coupled together via a private communication network of the private network system 102. The private network system 102 and the CSM system 104 are communicably coupled via a communication network 121.

The CSM system 104 includes and/or executes an event collection platform 105, a natural language processing (NLP) assistant platform 106, a data mapping platform 108, an exposed API platform 110, and an event database platform 112. The event database platform 112 includes one or more indexed databases. In some embodiments, the one or more indexed databases may be an elastic search cluster.

In some embodiments, the event collection platform 105 deploys a sensor onto each of the endpoint devices 101 of the private network system 102 by sending (e.g., broadcasting) messages to the endpoint devices 101. The messages cause the endpoint devices 101 to install the sensor onto its own resources (e.g., memory, storage, processor). For example, endpoint device 101a installs sensor 103a, endpoint device 101b installs sensor 103b, endpoint device 101c installs sensor 103c, and endpoint device 101d installs sensor 103d (each collectively referred to as, sensors 103).

In some embodiments, the event collection platform 105 does not need to deploy a sensor onto each of the endpoint devices 101, but instead can leverage an already existing and deployed sensor 103 which is also configured to send the necessary telemetry data for the event collection platform 105 to function.

Each sensor 103 is configured to monitor (e.g., track) and detect each event involving the endpoint device 101 that executes the sensor 103. An event may include, for example, a process control call, a file management call, a device management call, an information management call, a communication call, a protection call, and/or the like. An event may also include any communication (e.g., transmission/transmit, reception/receive) that takes place between the endpoint device 101 and any other computing device (e.g., endpoint device 101, admin device 115). Each communication includes a header (e.g., source network address, destination network address, and/or the like) and a message body (e.g., text, code, etc.). The sensor 103 also assigns a time stamp to the gathered event data (which also includes the communication data) and records (e.g., stores) the event data in a local storage (e.g., memory, database, cache) of the respective endpoint device 101. Therefore, each endpoint device 101 may use its sensor 103 to keep track all network addresses (e.g., internet protocol (IP) address, Media Access Control (MAC) address, telephone number, and/or the like) of the endpoint device 101 on the private network system 102 that are currently communication with the endpoint device 101 and/or have previously communicated (sometimes referred to as historical communication) with the endpoint device 101.

Each of the endpoint devices 101 of the private network system 102 periodically sends its locally stored event data to the event collection platform 105 of the CSM system 104. The event collection platform 105 determines which event type of a plurality of event types are associated with received event data. The event collection platform 105 indexes each of the event datasets into the event database platform 112 based on the event types that are associated with the event datasets. For example, the event collection platform 105 may determine that a first group of event datasets are indicative of threat data and store the first group of event datasets in a first location of the event database platform 112 that is reserved for threat data. The event collection platform 105 may determine that a second group of event datasets are indicative of detection data and store the second group of event datasets in a second location of the event database platform 112 that is reserved for detection data. The event collection platform 105 may determine that a third group of event datasets are indicative of vulnerability data and store the third group of event datasets in a third location of the event database platform 112 that is reserved for vulnerability data. The event collection platform 105 may determine that a fourth group of event datasets are indicative of application data (e.g., installs, etc.) and store the fourth group of event datasets in a fourth location of the event database platform 112 that is reserved for application data.

The exposed API platform 110 generates a group of APIs 111 that are each configured to access event data associated with a particular event type. For example, the exposed API platform 110 generates API 111a, which is configured to access the threat data from the event database platform 112; the exposed API platform 110 generates API 111b, which is configured to access the detection data from the event database platform 112; the exposed API platform 110 generates API 111c, which is configured to access the vulnerability data from the event database platform 112; and the exposed API platform 110 generates API 111d, which is configured to access the application data from the event database platform 112.

The data mapping platform 108 models the event data that is stored in the event database platform 112 by using schemas 109 (e.g., tables, data structures, and/or the like). For example, the data mapping platform 108 uses the API 111a to generate a schema 109a that includes (or references) the threat data in the event database platform 112; the data mapping platform 108 uses the API 111b to generate a schema 109b that includes (or references) the detection data in the event database platform 112; the data mapping platform 108 uses the API 111c to generate a schema 109c that includes (or references) the vulnerability data in the event database platform 112; and the data mapping platform 108 uses the API 111d to generate a schema 109d that includes (or references) the application data in the event database platform 112. The data mapping platform 108 generates mapping data that indicates the relationship between the schema 109, the APIs 111, and the event data in the event database platform 112. The data mapping platform 108 sends the mapping data to the NLP assistant platform 106, which in turn, uses the data mapping platform 108 to convert NL queries to SQL queries.

The NLP assistant platform 106 includes LLMs 107 (e.g., LLM 107a, LLM 107b, LLM 107c, LLM 107d) that are each trained to identify, based on an NL query and the mapping data, a particular API 111 that provides access to one or more event datasets associated with the NL request. The LLMs 107 convert the NL request to a SQL request to be used for communicating with the particular API 111.

The event collection platform 105, in some embodiments, uses training data to train each of the LLMs 107 of the NLP assistant platform 106 to identify, from the plurality of APIs, a particular API that provides access to one or more event datasets associated with the NL request. The event collection platform 105 may also use the training data to train each of the LLMs 107 of the NLP assistant platform 106 to convert the NL request to a SQL request to be used for communicating with the particular API. The training data may include a portion or all portions of the event data of the event database platform 112.

The event collection platform 105, in some embodiments, uses a structured platform query language which abstracts the APIs of the CSM system 104 in a descriptive manner. The event collection platform 105 may generate and/or use datasets that include different natural query examples with their translation to the database query (e.g., a structured platform query language). For example: “show me devices with critical vulnerabilities->QueryPlatform (SELECT device.id, device.name FROM spotlight.vulnerabilities WHERE severity=‘critical’)”. The event collection platform 105 may generate this dataset with expert users' writing templates, which may be expanded into multiple examples. The event collection platform 105 may train and/or fine-tune each of the LLMs 107 by (1) fine-tuning directly on a large dataset and/or (2) using embeddings to search for the most common examples, and then using a few-shots method in context learning at the feed forward operation with one or more of the LLMs 107.

Furthermore, there are several ways the event collection platform 105 may handle the NL query-to-query language (e.g., SQL). For example, the event collection platform 105 may use a few-shots method on an already existing LLM (e.g., LLMs 107), which is pre-configured to have a lot of knowledge about the query-to-query language (e.g., SQL). The event collection platform 105 may be configured to perform a semantic search over one or more of the available examples discussed herein (e.g., few-shots) and insert the relevant ones in a prompt and send it to one or more of the LLMs 107.

Alternatively, the event collection platform 105 may be configured to generate a dataset that contains examples of NL query (e.g., SQL) and then fine-tune an open-source LLM (e.g., Large Language Model Meta AI (LLaMa), Mistral) on the dataset. The event collection platform 105 may generate the dataset deterministically given that the event collection platform 105 may determine a range of patterns for NL queries and the schema/mapping of the API/databases that are associated with the query. In some embodiments, the event collection platform 105 and/or domain experts may construct the SQL queries from the dataset.

A communication network (e.g., communication network 121, a private communication network of the private network system 102) may include a wired or a wireless infrastructure, which may be provided by one or more wireless communications systems, such as wireless fidelity (Wi-Fi) connectivity to the communication network and/or a wireless carrier system that can be implemented using various data processing equipment, communication towers (e.g., cell towers), etc. The communication network may carry communications (e.g., data, message, packets, frames, etc.) between any other the computing device.

Still referring to FIG. 1, the CSM system 104 collects a plurality of event datasets from a plurality of endpoint devices of a private network system 102. Each event dataset (one or more items of event data) is respectively associated with a particular endpoint device 101 of the plurality of endpoint devices 101. The CSM system 104 indexes the plurality of event datasets into one or more databases based on a plurality of event types associated with the plurality of event datasets. For example, the CSM system 104 may determine that a first event dataset (e.g., one or more items of event data) are each indicative of threat data and store the first event dataset in a first location of the event database platform 112 that is reserved for threat data. The CSM system 104 may determine that a second event dataset are each indicative of detection data and store the second event dataset in a second location of the event database platform 112 that is reserved for detection data. The CSM system 104 may determine that a third event dataset are each indicative of vulnerability data and store the third event dataset in a third location of the event database platform 112 that is reserved for vulnerability data. The CSM system 104 may determine that a fourth event dataset are each indicative of application data (e.g., installs, etc.) and store the fourth event dataset in a fourth location of the event database platform 112 that is reserved for application data.

The CSM system 104 generates, for the plurality of databases, a plurality of APIs 111 associated with the plurality of event types. Each API 111 of the plurality of APIs 111 provides access to a unique event dataset associated with a unique event type of the plurality of event types. The CSM system 104 receives an NL request from an endpoint device 101 on the private network system 102. The CSM system 104 provides the NL request to one or more LLMs 107 of the NLP assistant platform 106, where each LLM is trained to identify, from the plurality of APIs 111, a particular API 11 that provides access to one or more event datasets associated with the NL request. The CSM system 104 converts, by the one or more LLMs 107, the NL request to a SQL request to be used for communicating with the particular API 111. The CSM system 104 provides, to the endpoint device 101 or the admin device 115, access to the one or more event datasets based on the SQL request. For example, the CSM system 104 may send the SQL request to the endpoint device 101 or the admin device 115, which in turn, may use the SQL request to access the one or more event datasets. Alternatively, the CSM system 104 may use the SQL request to retrieve the one or more event datasets and then forward the one or more event datasets to the endpoint device 101 or the admin device 115.

Although FIG. 1 shows only a select number of computing devices (e.g., CSM system 104, endpoint devices 101, admin devices 115) and private network systems; the environment 100 may include any number of computing devices and private network systems that are interconnected in any arrangement to facilitate the exchange of data between the computing devices and the private network systems.

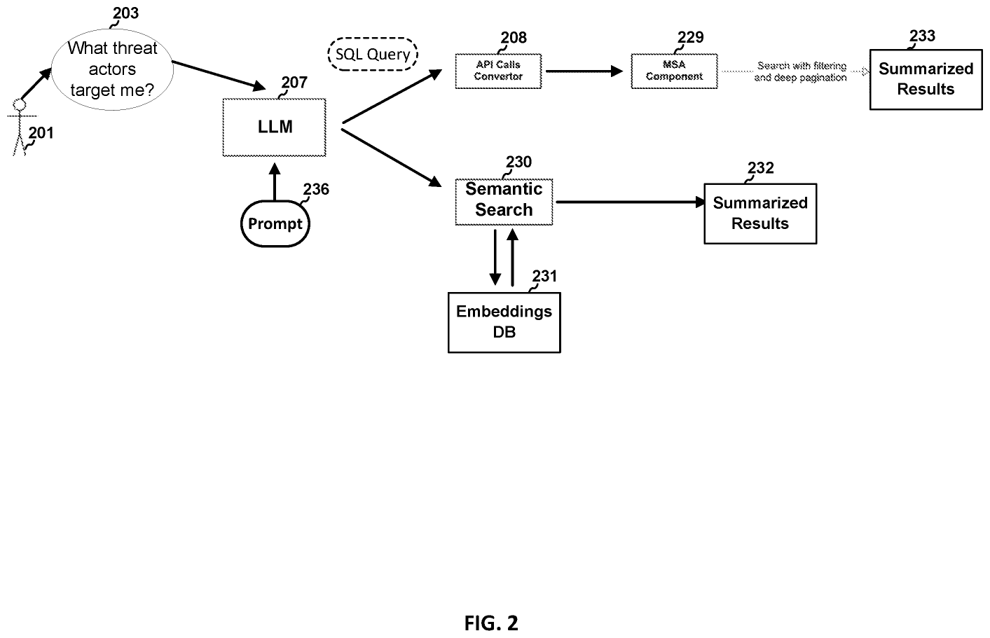

FIG. 2 is a block diagram depicting an example environment for using the LLMs in FIG. 1 to convert natural language queries to database commands for accessing one or more databases, according to some embodiments. The environment 200 includes a user 201, one or more LLMs 207, an API call convertor 208, a semantic search component 230, embeddings database (DB) 231, a micro service architecture (MSA) component 229. Each of the components in FIG. 2 may be included in the CSM system 104 in FIG. 1. For example, the one or more LLMs 207 may correspond to one or more of the LLMs 107 in FIG. 1. The API call convertor 208 and the MSA component 229 may each correspond to the data mapping platform 108 in FIG. 1. The CSM system 104 trains the one or more LLMs 207 to identify, from the plurality of APIs 111 of the exposed API platform 110, a particular API that provides access to one or more event datasets associated with the NL request. The CSM system 104 may also use the training data to train each of the LLMs 207 of the NLP assistant platform 106 to convert the NL request to a SQL request to be used for communicating with the particular API 111. The training data may include a portion or all portions of the event data of the event database platform 112.

An admin device 115 on a private network system 102 executes the application 113 (e.g., sometimes referred to as, Falcon UI viewer). A user 201 uses the application 113 to send platform-specific questions to the CSM management system (sometimes referred to an NLP assistant). The platform-specific questions may be, for example, “Which threat actors target my industry?”, “What is my exposure to CVE-2023-12345?” or “Which hosts in my environment have Team Viewer or Any Desk installed?” The CSM system 104 generates answers to the platform-specific questions that are made up of a summarized response enclosing the resources and/or data (e.g., event data) of interest to the user as specified by the question, formatted and beautified in a human-readable way. Furthermore, the user 201 may ask the CSM system 104 questions (e.g., query 203) that cannot be directly mapped to specific data platform queries, but imply general concepts that are widely used in the cybersecurity space. The CSM system 104 can help users that are not that technical to ask the right questions, by providing context whenever a question like that comes up.

The one or more LLM 207 are each configured with a predefined prompt 236 that provides them with all the details (e.g., tables definitions/schema, mapping data, API 111 names, database names, and/or the like) of the CSM system 104. The predefined prompt 236 is augmented each time with the user's questions (e.g., query 203) and served to the one or more LLMs 207. The LLMs 207 may generate a response that is a specific query in a Structured Query Language (SQL) and send the response to the API calls convertor 208. SQL is a declarative language that LLMs are able to write and is easier to map (e.g., convert) to from natural language. Alternatively, the LLMs 207 may generate a response that is a delegation of the question and send the response to the semantic search component 230.

The API calls convertor 208 includes built-in logic that maps (e.g., converts) SQL to specific API calls that can handle the query 203. The API calls convertor 208 sends the API calls to the MSA component 229.

The MSA component 229 runs the one or more queries 203 against the appropriate APIs. The MSA component 229 handles deep pagination and filtering by different fields.

The semantic search component 230 leverages a pre-built embeddings database 231 to match requests that cannot directly be mapped to a data platform structured language query. The embeddings database 231 is stored in an elastic search cluster and provides context by using similarity between the user's 201 initial question (e.g., query 203) and sequences of information from a large corpus of intelligence made up by intelligence reports, APIs documentation, and/or the like.

Thus, the CSM system 104 uses the LLMs 207 to build a natural language interface which simplifies user interaction with the CSM system 104. The CSM system 104 offers observability into a customer's cyber threats by ingesting and indexing multiple data points from their environment. Besides interacting with the CSM system 104, the interface provides guidance regarding how a user 201 may use it, suggesting common queries. This guidance is built by leveraging the LLMs 207 and semantic search component 230 based on the embeddings database 231 and/or a vector database.

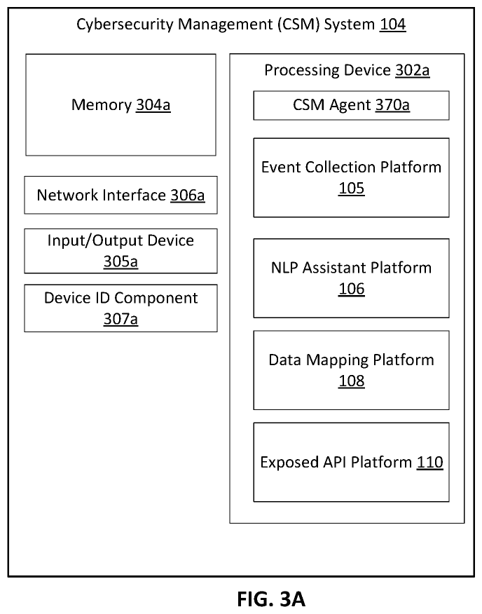

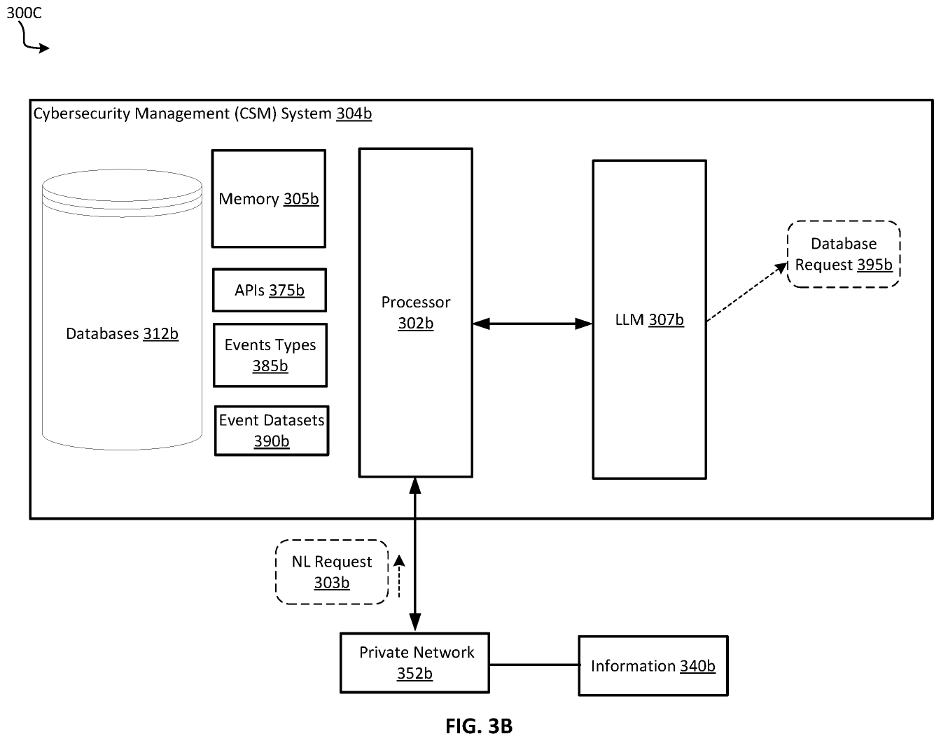

FIG. 3A is a block diagram depicting an example of the cybersecurity management (CSM) system in FIG. 1, according to some embodiments. While various devices, interfaces, and logic with particular functionality are shown, it should be understood that the CSM system 104 includes any number of devices and/or components, interfaces, and logic for facilitating the functions described herein. For example, the activities of multiple devices may be combined as a single device and implemented on the same processing device (e.g., processing device 302a), as additional devices and/or components with additional functionality are included.

The CSM system 104 includes a processing device 302a (e.g., general purpose processor, a PLD, etc.), which may be composed of one or more processors, and a memory 304a (e.g., synchronous dynamic random-access memory (DRAM), read-only memory (ROM)), which may communicate with each other via a bus (not shown).

The processing device 302a may be provided by one or more general-purpose processing devices such as a microprocessor, central processing unit, a graphic processing unit (GPU), or the like. In some embodiments, processing device 302a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 302a may include one or more special-purpose processing devices such as an application specific integrated circuit (ASIC), a field programmable gate array (FPGA), a digital signal processor (DSP), network processor, or the like. The processing device 302a may be configured to execute the operations described herein, in accordance with one or more aspects of the present disclosure, for performing the operations and steps discussed herein.

The memory 304a (e.g., Random Access Memory (RAM), Read-Only Memory (ROM), Non-volatile RAM (NVRAM), Flash Memory, hard disk storage, optical media, etc.) of processing device 302a stores data and/or computer instructions/code for facilitating at least some of the various processes described herein. The memory 304a includes tangible, non-transient volatile memory, or non-volatile memory. The memory 304a stores programming logic (e.g., instructions/code) that, when executed by the processing device 302a, controls the operations of the CSM system 104. In some embodiments, the processing device 302a and the memory 304a form various processing devices and/or circuits described with respect to the CSM system 104. The instructions include code from any suitable computer programming language such as, but not limited to, C, C++, C#, Java, JavaScript, VBScript, Perl, HTML, XML, Python, TCL, and Basic.

The processing device 302a executes a CSM agent 370, an event collection platform 105, an NLP assistant platform 106, a data mapping platform 108, and an exposed API platform 110. In some embodiments, any of the CSM agent 370, then event collection platform 105, the NLP assistant platform 106 (including one or more of its models), the data mapping platform 108, and the exposed API platform 110 may be combined into a single entity that includes all the functions and features of its individual parts.

The CSM agent 370 may be configured to use the event collection platform 105 to receive a NL request for information associated with the private network system 102. The CSM agent 370 may be configured to generate, for a plurality of databases, a plurality of APIs associated with a plurality of event types. Each API of the plurality of APIs provides access to a unique event dataset associated with a unique event type of the plurality of event types. The CSM agent 370 may be configured to provide the NL request to the NLP assistant platform 106, which includes LLMs 107a that are each trained to identify, from the plurality of APIs, a particular API that provides access to one or more event datasets associated with the NL request. The CSM agent 370 may be configured to generate, using the NLP assistant platform 106, a database request associated with the particular API based on the NL request.

The CSM agent 370 may be configured to use the event collection platform 105 to collect the plurality of event datasets from the endpoint devices 101 of the private network system 102. The CSM agent 370 may be configured to index the plurality of event datasets into the plurality of databases based on the plurality of event types.

The CSM agent 370 may be configured to index the plurality of event datasets into the plurality of databases based on the plurality of event types by determining that a first dataset of the plurality of event datasets is indicative of a first event type of the plurality of event types; determining that a second dataset of the plurality of event datasets is indicative of a second event type of the plurality of event types; and storing the first dataset in a first database of the plurality of databases and the second dataset in a second database of the plurality of databases.

The CSM agent 370 may be configured to generate, using a first API (e.g., API 111a) of the plurality of APIs, a first schema (e.g., schema 109a) that indicates a first dataset stored in a first database of the plurality of databases, the first dataset is associated with a first event type (e.g., threat data). The CSM agent 370 may be configured to generate, using a second API (e.g., API 111b) of the plurality of APIs, a second schema (e.g., schema 109b) that indicates a second dataset stored in a second database of the plurality of databases, the second dataset is associated with a second event type (e.g., detection data).

The CSM agent 370 may be configured to generate mapping data that indicates a relationship between the plurality of databases and the plurality of APIs. The CSM agent 370 may be configured to generate the database request associated with the particular API based on the mapping data.

The CSM agent 370 may be configured to generate, using the NLP assistant platform 106, the database request associated with the particular API based on the NL request by converting the NL request to the database request associated with the particular API.

The CSM agent 370 may be configured to provide, to an endpoint device (e.g., endpoint device 101a), access to the one or more event datasets based on the database request. For example, the CSM agent 370 may provide the database request that is associated with the particular API request to the endpoint device 101a, which in turn, may use the database request to communicate with the particular API to access the one or more event datasets.

In some embodiments, the plurality of event types are each indicative of at least one of detection data, vulnerability data, or application data. In some embodiments, the NL request is for one or more of the following: an identifier of one or more threat actors associated with a particular industry; a factor indicating a degree of exposure that a particular computing device has to a particular threat type; or an identifier of one or more hosts with a particular installed application. In some embodiments, the database request is a structured query language (SQL) request.

The CSM system 104 includes a network interface 306a configured to establish a communication session with a computing device for sending and receiving data over the communication network 121 to the computing device. Accordingly, the network interface 306a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the CSM system 104 includes a plurality of network interfaces 306a of different types, allowing for connections to a variety of networks, such as local area networks (public or private) or wide area networks including the Internet, via different sub-networks.

The CSM system 104 includes an input/output device 305a configured to receive user input from and provide information to a user. In this regard, the input/output device 305a is structured to exchange data, communications, instructions, etc. with an input/output component of the CSM system 104. Accordingly, input/output device 305a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of the CSM system 104, such as a built-in display, touch screen, microphone, etc., or external to the housing of the CSM system 104, such as a monitor connected to the CSM system 104, a speaker connected to the CSM system 104, etc., according to various embodiments. In some embodiments, the CSM system 104 includes communication circuitry for facilitating the exchange of data, values, messages, and the like between the input/output device 305a and the components of the CSM system 104. In some embodiments, the input/output device 305a includes machine-readable media for facilitating the exchange of information between the input/output device 305a and the components of the CSM system 104. In still another embodiment, the input/output device 305a includes any combination of hardware components (e.g., a touchscreen), communication circuitry, and machine-readable media.

The CSM system 104 includes a device identification component 307a (shown in FIG. 3A as device ID component 307a) configured to generate and/or manage a device identifier associated with the CSM system 104. The device identifier may include any type and form of identification used to distinguish the CSM system 104 from other computing devices. In some embodiments, to preserve privacy, the device identifier may be cryptographically generated, encrypted, or otherwise obfuscated by any device and/or component of the CSM system 104. In some embodiments, the CSM system 104 may include the device identifier in any communication (e.g., classifier performance data, input message, parameter message, etc.) that the CSM system 104 sends to a computing device.

The CSM system 104 includes a bus (not shown), such as an address/data bus or other communication mechanism for communicating information, which interconnects the devices and/or components of the CSM system 104, such as processing device 302a, network interface 306a, input/output device 305a, and device ID component 307a.

In some embodiments, some or all of the devices and/or components of CSM system 104 may be implemented with the processing device 302a. For example, the CSM system 104 may be implemented as a software application stored within the memory 304a and executed by the processing device 302a. Accordingly, such embodiment can be implemented with minimal or no additional hardware costs. In some embodiments, any of these above-recited devices and/or components rely on dedicated hardware specifically configured for performing operations of the devices and/or components.

FIG. 3B is a block diagram depicting an example environment for using a CSM system, according to some embodiments. The environment 300b includes a CSM system 304b, such as CSM system 104 in FIG. 1. The CSM system 304b includes a memory 305b and a processing device 302b that is operatively coupled to the memory 305b. The processing device 302b receives an NL request 303b for information 340b associated with a private network 352b. The processing device 302b generates, for a plurality of databases 312b, a plurality of APIs 375b associated with a plurality of event types 385b. Each API of the plurality of APIs 375b provides access to a unique event dataset 390b associated with a unique event type of the plurality of event types 385b. The processing device 302b provides the NL request 303b to an LLM 307b trained to identify, from the plurality of APIs 375b, a particular API that provides access to one or more event datasets 390b associated with the NL request 303b. The processing device 302b generates, using the LLM 307b, a database request 395b associated with the particular API based on the NL request 303b.

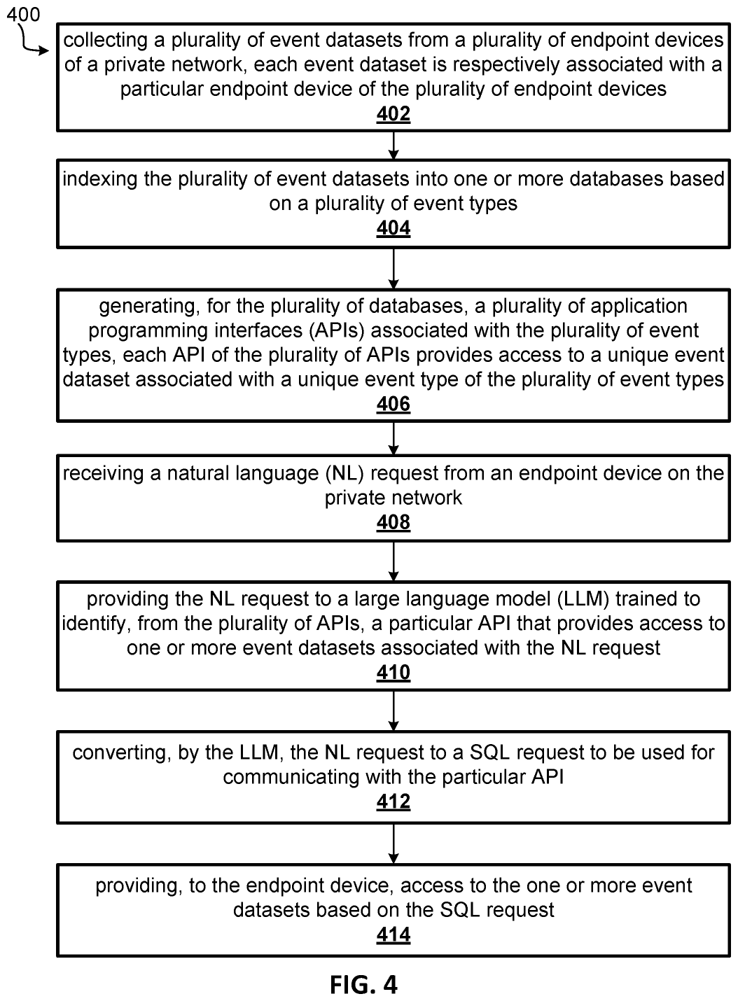

FIG. 4 is a flow diagram depicting a method of using generative artificial intelligence to convert natural language queries to database commands for accessing one or more databases, according to some embodiments. Method 400 may be performed by processing logic that may include hardware (e.g., circuitry, dedicated logic, programmable logic, a processor, a processing device, a central processing unit (CPU), a graphic processing unit (GPU), a system-on-chip (SoC), etc.), software (e.g., instructions running/executing on a processing device), firmware (e.g., microcode), or a combination thereof. In some embodiments, method 400 may be performed by a cybersecurity management (CSM) system, such as the CSM system 104 in FIG. 1. In some embodiments, method 400 may be performed by one or more computing devices of a private network system, such as private network system 102 in FIG. 1.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

The method 400 includes the block 402 of collecting a plurality of event datasets from a plurality of endpoint devices of a private network, each event dataset is respectively associated with a particular endpoint device of the plurality of endpoint devices. The method 400 includes the block 404 of indexing the plurality of event datasets into one or more databases based on a plurality of event types. The method 400 includes the block 406 of generating, for the plurality of databases, a plurality of APIs associated with the plurality of event types, each API of the plurality of APIs provides access to a unique event dataset associated with a unique event type of the plurality of event types. The method 400 includes the block 408 of receiving a NL request from an endpoint device on the private network. The method 400 includes the block 410 of providing the NL request to an LLM trained to identify, from the plurality of APIs, a particular API that provides access to one or more event datasets associated with the NL request. The method 400 includes the block 412 of converting, by the LLM, the NL request to a SQL request to be used for communicating with the particular API 111. The method 400 includes the block 414 of providing, to the endpoint device, access to the one or more event datasets based on the SQL request.

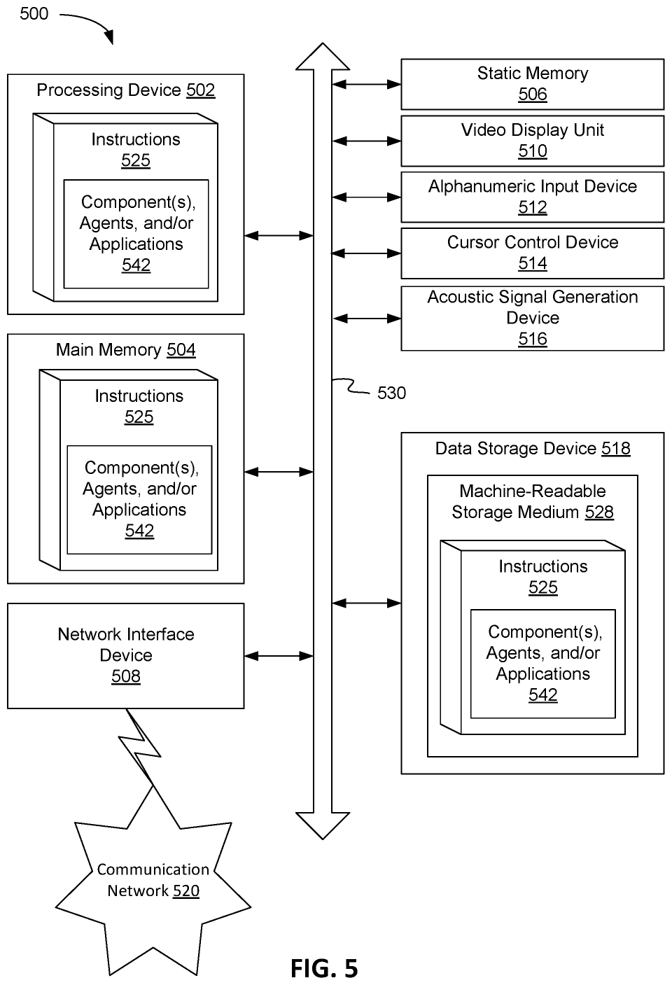

FIG. 5 is a block diagram of an example computing device 500 that may perform one or more of the operations described herein, in accordance with some embodiments. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general-purpose processor, a PLD, etc.) 502, a main memory 504 (e.g., synchronous dynamic random-access memory (DRAM), read-only memory (ROM)), a static memory 506 (e.g., flash memory and a data storage device 518), which may communicate with each other via a bus 530.

Processing device 502 may be provided by one or more general-purpose processing devices such as a microprocessor, central processing unit, or the like. In an illustrative example, processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also include one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a communication network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of instructions 525 that may include instructions for one or more components/programs/applications/platforms 542 (e.g., event collection platform 105, NLP assistant platform 106, data mapping platform 108, exposed API platform 110, and event database platform 112 in FIG. 1, etc.) for carrying out the operations described herein, in accordance with one or more aspects of the present disclosure. Instructions 525 may also reside, completely or at least partially, within main memory 504 and/or within processing device 502 during execution thereof by computing device 500, main memory 504 and processing device 502 also constituting computer-readable media. The instructions 525 may further be transmitted or received over a communication network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “generating,” “providing,” “collecting,” “indexing,” “determining,” “storing,” “converting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112 (f), for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

What is claimed is:

1. A method comprising:
receiving a natural language (NL) request for information associated with a private network;
providing the NL request to an artificial intelligence (AI) model trained to identify, from a plurality of access objects associated with a plurality of databases and a plurality of event types, a particular access object that provides access to one or more event datasets associated with the NL request; and
generating, by a processing device and using the AI model, a database request associated with the particular access object based on the NL request.

2. The method of claim 1, further comprising:
collecting the plurality of event datasets from a plurality of endpoint devices of the private network; and
indexing the plurality of event datasets into the plurality of databases based on the plurality of event types.

3. The method of claim 2, wherein indexing the plurality of event datasets into the plurality of databases based on the plurality of event types comprises:
determining that a first dataset of the plurality of event datasets is indicative of a first event type of the plurality of event types;
determining that a second dataset of the plurality of event datasets is indicative of a second event type of the plurality of event types; and
storing the first dataset in a first database of the plurality of databases and the second dataset in a second database of the plurality of databases.

4. The method of claim 2, further comprising:
generating, using a first access object of the plurality of access objects, a first schema that indicates a first dataset stored in a first database of the plurality of databases, the first dataset is associated with a first event type; and
generating, using a second access object of the plurality of access objects, a second schema that indicates a second dataset stored in a second database of the plurality of databases, the second dataset is associated with a second event type.

5. The method of claim 2, further comprising:
generating mapping data that indicates a relationship between the plurality of databases and the plurality of access objects,
wherein generating the database request associated with the particular access object is further based on the mapping data.

6. The method of claim 1, further comprising:
converting the NL request to the database request associated with the particular access object.

7. The method of claim 1, further comprising:
providing, to an endpoint device, access to the one or more event datasets based on the database request.

8. The method of claim 1, wherein the plurality of event types is indicative of at least one of detection data, vulnerability data, or threat data.

9. The method of claim 1, wherein the NL request is for one or more of the following:
an identifier of one or more threat actors associated with a particular industry;
a factor indicating a degree of exposure that a particular computing device has to a particular threat type; or
an identifier of one or more hosts with a particular installed application.

10. The method of claim 1, wherein the database request is a structured query language (SQL) request.

11. A system comprising:
a memory; and
a processing device, operatively coupled to the memory, to:
receive a natural language (NL) request for information associated with a private network;
provide the NL request to an artificial intelligence (AI) model trained to identify, from a plurality of access objects associated with a plurality of databases and a plurality of event types, a particular access object that provides access to one or more event datasets associated with the NL request; and
generate, using the AI model, a database request associated with the particular access object based on the NL request.

12. The system of claim 11, wherein the processing device is further to:
collect the plurality of event datasets from a plurality of endpoint devices of the private network; and
index the plurality of event datasets into the plurality of databases based on the plurality of event types.

13. The system of claim 12, wherein to index the plurality of event datasets into the plurality of databases based on the plurality of event types, the processing device is further to:
determine that a first dataset of the plurality of event datasets is indicative of a first event type of the plurality of event types;
determine that a second dataset of the plurality of event datasets is indicative of a second event type of the plurality of event types; and
store the first dataset in a first database of the plurality of databases and the second dataset in a second database of the plurality of databases.

14. The system of claim 12, wherein the processing device is further to:
generate, using a first access object of the plurality of access objects, a first schema that indicates a first dataset stored in a first database of the plurality of databases, the first dataset is associated with a first event type; and
generate, using a second access object of the plurality of access objects, a second schema that indicates a second dataset stored in a second database of the plurality of databases, the second dataset is associated with a second event type.

15. The system of claim 12, wherein the processing device is further to:
generate mapping data that indicates a relationship between the plurality of databases and the plurality of access objects,
wherein to generate the database request associated with the particular access object is further based on the mapping data.

16. The system of claim 11, wherein the processing device is further to:
convert the NL request to the database request associated with the particular access object.

17. The system of claim 11, wherein the processing device is further to:
provide, to an endpoint device, access to the one or more event datasets based on the database request.

18. The system of claim 11, wherein the plurality of event types is indicative of at least one of detection data, vulnerability data, or threat data.

19. The system of claim 11, wherein the NL request is for one or more of the following:
an identifier of one or more threat actors associated with a particular industry;
a factor indicating a degree of exposure that a particular computing device has to a particular threat type; or
an identifier of one or more hosts with a particular installed application.

20. A non-transitory computer-readable medium storing instructions that, when execute by a processing device, cause the processing device to:
receive a natural language (NL) request for information associated with a private network;
provide the NL request to an artificial intelligence (AI) model trained to identify, from a plurality of access objects associated with a plurality of databases and a plurality of event types, a particular access object that provides access to one or more event datasets associated with the NL request; and
generate, by the processing device and using the AI model, a database request associated with the particular access object based on the NL request.
